(19) United States
(12) Patent Application Publication
(10) Pub. No.: US 2021/0363973 A1
(43) Pub. Date: Nov. 25, 2021

(54) METHOD FOR DETERMINING THE WEAR OF A SLIDING BEARING MOUNTED IN A WIND TURBINE TRANSMISSION, AND WIND TURBINE TRANSMISSION

(71) Applicant: Miba Gleitlager Austria GmbH, Laakirchen (AT)

(72) Inventor: Johannes Sebastian HOELZL, Berg im Attergau (AT)

(73) Assignee: Miba Gleitlager Austria GmbH, Laakirchen (AT)

(21) Appl. No.: 16/979,947

(22) PCT Filed: Mar. 26, 2019
(86) PCT No.: PCT/AT2019/060103

§ 371 Date: Sep. 11, 2020

(30) Foreign Application Priority Data
Mar. 27, 2018 (DE) 10 2018 002 509.9

(51) Int. Cl. F03D 17/00; F03D 80/70; F03D 15/00

(52) U.S. Cl. CPC F03D 17/00; F03D 80/70; F03D 15/00; F05B 2240/50; F05B 2270/305; F05B 2260/80; F05B 2270/821; F05B 2260/40311

(57) ABSTRACT

The invention relates to a method for determining the wear of a sliding bearing (19) arranged in a wind turbine gearbox (7), in particular a planetary gearbox, which sliding bearing (19) serves for mounting a gearbox component (23). A radial displacement of the position of the gearbox component (23) pivoted by means of the sliding bearing (19) is detected by means of a distance sensor (25) arranged in the wind turbine gearbox (7).

The invention relates to a method for determining the wear of a sliding bearing arranged in a wind turbine gearbox and a wind turbine gearbox equipped with a wear measurement.

Wind turbine gearboxes in the form of planetary gearboxes are known from EP 1 544 504 A2 or AT 509 624 A1. In this respect, sliding bearing bushes which are shrunk onto the axle or pressed into the planetary gear are most commonly used. These must be removed for monitoring the wear condition of the sliding bearings, which entails great effort and high costs.

The object of the present invention was to overcome the disadvantages of the prior art and to provide a method and a device by means of which the wear condition of the bearings can be determined in a simplified manner.

The object is achieved by means of a method and a wind turbine gearbox according to the claims.

According to the invention, a method is provided for determining the wear of a sliding bearing arranged in a wind turbine gearbox, in particular a planetary gearbox, which sliding bearing serves for mounting a gearbox component. A radial displacement of the position or a tilting of the gearbox component pivoted by means of the sliding bearing is detected by means of a distance sensor arranged in the wind turbine gearbox.

The at least one distance sensor can serve, in particular, for detecting the radial displacement of the position of the gearbox component.

In a further embodiment variant, it can also be provided that the gearbox component is equipped with two distance sensors and therefore, the tilting of the gearbox component can also be detected. In this, the two distance sensors can be arranged offset to one another with respect to the longitudinal direction of the axle of the gearbox component in order to be able to calculate the tilting based on the different displacement at the two distance sensors. The method according to the invention offers the advantage that a wear of the sliding bearing can be extrapolated from the distance sensor and/or the values determined by the distance sensor. Therefore, the wind turbine does not have to be stopped to allow determining the current wear condition of the sliding bearings in the wind turbine gearbox. This avoids a complicated and cost-intensive disassembly of the gearbox, which serves for monitoring the wear condition. In particular, an abruptly-occurring excessive wear can be detected and the causes for this can be clarified in a timely manner by means of the method according to the invention. Furthermore, the method entails the advantage that the sliding bearings can be in use up to their maximum wear limit, whereby the repair intervals as well as the maintenance intervals for the wind turbine gearbox can be extended as compared to conventional wind turbine gearboxes. This is particularly advantageous as any down time of the wind turbine entails energy losses and thus, also economical losses.

Moreover, it can be useful if the distance sensor detects the displacement of the gearbox component in periodical intervals, and the measured values are saved in a wear chart. This measure entails the advantage that the temporal progression of the wear of the sliding bearing can be documented and/or read. By means of this measure, a necessary maintenance can be scheduled with sufficient notice.

Furthermore, it can be provided that, for the radial displacement, target values with tolerance ranges are predetermined for a certain time of detection, and the actual values detected by means of the distance sensor are compared with said target values, wherein an action is triggered if an actual value lies outside the tolerance range of an assigned target value. By means of this measure, for example, a warning signal can be issued to the maintenance staff, so that a maintenance can be scheduled.

According to the invention, a wind turbine gearbox, in particular planetary gearbox, having at least one sliding bearing for mounting a gearbox component is provided. A wear sensor is designed in the form of a distance sensor for detecting a radial displacement of the position of the gearbox component pivoted by means of the sliding bearing.

In this document, the function of the distance sensor is described with reference to a planetary gearbox. When using the distance sensor in a planetary gearbox, it may be necessary that the distance sensor is rotated along with the planetary gear. Here, a wireless data transmission system may be necessary for transmitting the data of the distance sensor to a receiving station outside the gearbox.

Of course, it is also conceivable that the distance sensor for wear determination is used in a spur gear stage bearing.

The wind turbine gearbox according to the invention has the advantage that, by means of the distance sensor, the wear of the sliding bearing can be detected.

An embodiment is also advantageous, according to which it can be provided that the distance sensor is arranged on a planetary gear carrier and is designed for the detection of the radial displacement of the position of the planetary gear axle, in particular that the distance sensor is arranged on the planetary gear carrier so as to detect the distance in the tangential direction. By this measure, the individual sliding bearings, which serve for mounting the planetary gear axle, can be detected by means of the distance sensor. The arrangement of the distance sensor on the planetary gear carrier in the tangential direction entails the advantage that a radial displacement of the planetary gear axle in the tangential direction of the planetary gear carrier can be directly detected. As the forces acting on the planetary gear axle act on the sliding bearing, also primarily in the tangential direction of the planetary gear carrier, the displacement of the planetary gear axle can therefore be detected directly in the main direction of wear.

According to a further embodiment, it is possible that a permanent magnet is arranged in the planetary gearbox such that the distance sensor, which is arranged on the planetary gear carrier so as to rotate along with it, can be supplied or charged with electricity by means of induction. This measure allows to achieve an energy supply of the distance sensor.

Moreover, it can be useful if a laser sensor is formed as a distance sensor. This entails the advantage that a laser sensor can have a high detection accuracy and beyond that, can be built in a simple manner.

Furthermore, it can be provided that a marking is arranged on the gearbox component, which marking serves as a reference for the distance sensor, in particular that the marking is formed as a reflector point which is arranged on the planetary gear axle. This measure allows to in-crease the detection accuracy of the distance sensor.

In particular, it can be provided that the marking is glued directly to the gearbox component.

In an alternative variant, it can also be provided that a recess is formed in the gearbox component, in which recess a marking is arranged.

Moreover, it can be provided that the distance sensor is arranged on the bearing seat of the sliding bearing. Therefore, the direct displacement of the gearbox component relative to the bearing seat can be detected.

According to a particular embodiment, it is possible that the distance sensor is arranged on the bearing seat such that a radial displacement of the position of the gearbox component pivoted by means of the sliding bearing in the main direction of loading can be detected. By this measure, the relevant wear of the sliding bearing can be detected.

In particular, it can be provided that the distance sensor is formed as a laser sensor, wherein the laser sensor is arranged in the wind turbine gearbox such that a laser beam of the laser sensor is oriented to be approximately parallel to the main direction of loading. Here, approximately parallel is understood to also include a deviation of the laser beam of +/−15° from the parallelism to the main direction of force.

For the purpose of better understanding of the invention, it will be elucidated in more detail by means of the figures below.

These show in a respectively very simplified schematic representation:

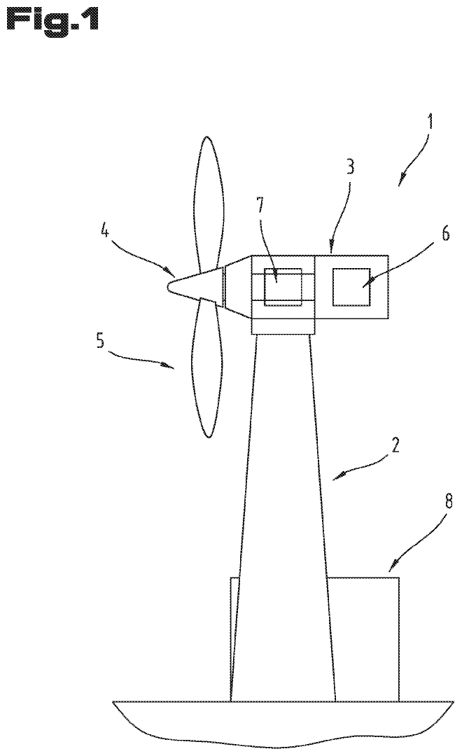

FIG. 1 a side view of a wind turbine;

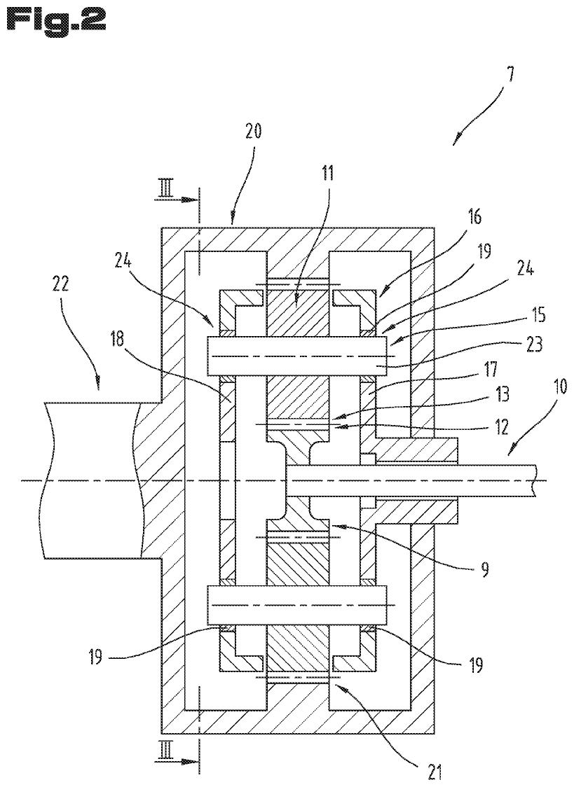

FIG. 2 a half-section of a wind turbine gearbox in the form of a planetary gearbox;

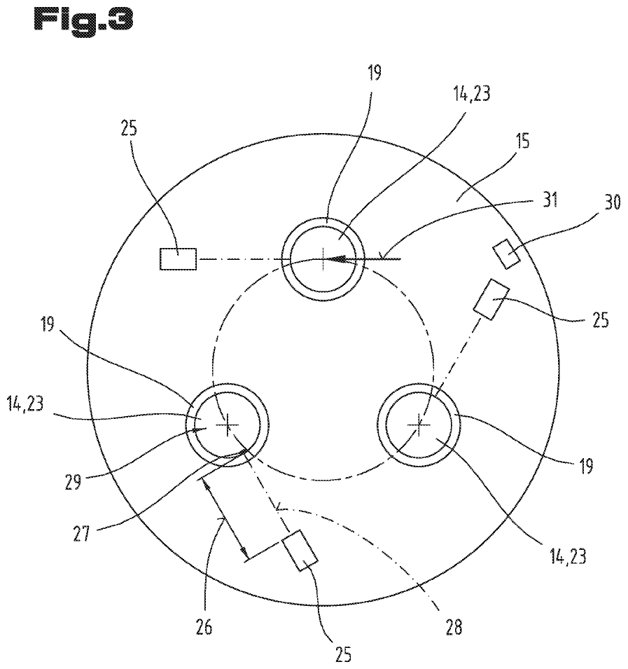

FIG. 3 a view of a planetary gear carrier with distance sensors arranged thereon.

First of all, it is to be noted that in the different embodiments described, equal parts are provided with equal reference numbers and/or equal component designations, where the disclo-sures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position.

FIG. 1 shows a wind turbine 1. This wind turbine 1 generally corresponds to the prior art, meaning that it comprises a tower 2 on which a nacelle 3 is arranged, on the front end of which a rotor 4 with rotor blades 5 and on the back end of which a generator 6 are arranged. A wind turbine gearbox 7, which is connected on the one hand to the rotor 4 and on the other hand to the moving member of the generator 6, is arranged between the rotor 4 and the generator 6, i.e. a not further represented moving member of the generator. The wind turbine gearbox 7 serves for increasing the rotation speed of the moving member as compared to the rotor 4. On the lower part of the tower 2, lastly, there is a network connection 8.

As these components are generally known from the prior art for wind turbines 1, reference is made here to the relevant literature on this subject. However, it should be mentioned that the wind turbine 1 is not obligatorily limited to the type represented in FIG. 1.

FIG. 2 shows an exemplary embodiment of the wind turbine gearbox 7 in the form of a simple planetary gearbox in a side view.

The planetary gearbox 7 has a sun gear 9 connected in a motion-coupled manner to a shaft 10 leading to the generator rotor. The sun gear 9 is surrounded by multiple planetary gears 11, for example two, preferably three or four. Both the sun gear 9 and the planetary gears 11 have outer end toothings 12, 13 which are engaged in a meshing arrangement, wherein these end toothings 12, 13 are schematically represented in FIG. 2.

The planetary gears 11 are held in the planetary carrier 15 by means of a planetary gear axle 14, wherein a first receiving section 16 and a second receiving section 17 are provided in the planetary carrier 15. As it can be seen in FIG. 2, it can be provided that the planetary gears 11 are solidly coupled with a planetary gear axle 14, and the planetary gear axles 14 are rotatably held in the receiving sections 16, 17.

In particular, it can be provided that the planetary gear axles 14 are mounted in the receiving sections 16, 17 by means of sliding bearings 19. The sliding bearings 19 can be designed, for example, in the form of sliding bearing bushes.

In an alternative exemplary embodiment, it can be provided that the planetary gear axles 14 are clamped in the receiving sections 16, 17, and the planetary gears 11 are pivoted, by means of sliding bearings 19, on the planetary gear axles 14 so as to be rotatable relative to them.

An internal gear 20 is arranged to surround the planetary gears 11, which internal gear 20 has an internal toothing 21 which is engaged in a meshing arrangement with the end toothing 13 of the planetary gears 11. The internal gear 20 is motion-coupled with a rotor shaft 22 of the rotor of the wind turbine. The end toothings 12, 13 and/or the internal toothing 21 can be formed as spur toothing, as helical toothing or as double helical toothing.

As such planetary gearboxes 7 are in principle also already known from the prior art, for example from the previously cited document regarding the prior art, further explanations are su-perfluous here.

In this document, the term gearbox component 23 is used for the component which is pivoted, by means of the sliding bearing 19, on another component, which is referred to as bearing seat 24, so as to be rotatable relative to the same.

For example, the planetary gear 11 can be referred to as gearbox component 23 if it is pivoted, by means of the sliding bearing 19, on the planetary gear axle 14 so as to be rotatable relative to the same.

In another exemplary embodiment, the planetary gear axle 14 can be referred to as gearbox component 23 if it is pivoted, by means of the sliding bearing 19, on the receiving sections 16, 17 so as to be rotatable relative to them.

In FIG. 3, a further and possibly independent embodiment of the wind turbine gearbox 7 is shown, wherein again equal reference numbers and/or component designations are used for equal parts as in the preceding FIGS. 1 and 2. In order to avoid unnecessary repetitions, it is pointed to/reference is made to the detailed description in FIGS. 1 and 2 preceding it.

In FIG. 3, the planetary carrier 15 is shown in a frontal view according to the view III-III from FIG. 2.

As it can be seen in FIG. 3, it can be provided that distance sensors 25 are formed which serve for the detection of the position and/or the position displacement of the gearbox component 23. The distance sensors 25 can serve, in particular, for detecting the radial displacement of the position of the gearbox component 23. In this case, the gearbox component 23 is the planetary gear axle 14 which is pivoted, by means of the sliding bearings 19, in the planetary carrier 15 so as to be rotatable.

By means of the distance sensor 25, a distance 26 of the surface of the planetary gear axle 14 to the distance sensor 25 can be detected. The change in the measured distance 26 over time gives information on the wear condition of the sliding bearing 19.

In order to improve the measurement accuracy, it can be provided that, on the gearbox component 23, a marking 27 is formed, which cooperates with the distance sensor 25. In the present exemplary embodiment according to FIG. 3, for example, the distance sensor 25 is designed in the form of a laser sensor and the marking 27 in the form of a reflector for reflecting a laser beam 28 of the distance sensor 25. In this process, the distance 26 is measured between the distance sensor 25 and the surface of the marking 27.

In particular, the distance sensor 25 can be arranged on the planetary carrier 15 such that the laser beam 28 acts, in the tangential direction, on a rotation center diameter, on which the individual rotation centers 29 of the planetary gear axle 14 are arranged. Since the main direction of loading 31 of the planetary gear axles 14, as well, extends to the rotation center diameter in the tangential direction, the laser beam 28 therefore lies in parallel with the main direction of loading 31 of the planetary gear axles 14. Therefore, the relevant wear in the main direction of loading 31 can be detected.

Moreover, one or multiple permanent magnet(s) 30 may be arranged in the internal gear 20, to which the planetary carrier 15 rotates. Due to these permanent magnets 30, an energy supply of the distance sensors 25 can be achieved by means of induction. Moreover, it can be provided that the distance sensors 25 are equipped with a wireless signal transmission means, by means of which the measured distance can be transmitted to a receiving location.

In a first exemplary embodiment, it can be provided, as depicted in FIG. 3, that a separate distance sensor 25 is formed for each of the planetary gear axles 14. Therefore, the wear condition of each of the sliding bearings 19 assigned to the planetary gear axles 14 can be moni-tored.

In a further exemplary embodiment that is not depicted, it can also be provided that only one distance sensor 25 is formed, which detects the displacement of one of the planetary gear axles 14, and that it is assumed that all sliding bearings of the planetary gear axles 14 are subject to the same wear.

In a further exemplary embodiment that is not depicted, it can be provided that the planetary gears 11 are pivoted, by means of the sliding bearings 19, on the planetary gear axles 14 so as to be rotatable relative to them. In such an exemplary embodiment, the distance sensor 25 can, for example, directly detect the position and/or the displacement of the planetary gear 11.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the teaching for technical action provided by the present invention lies within the ability of the person skilled in the art in this technical field.

The scope of protection is determined by the claims. However, the description and the draw-ings are to be adduced for construing the claims. Individual features or feature combinations from the different exemplary embodiments shown and described may represent independent inventive solutions. The object underlying the independent inventive solutions may be gath-ered from the description.

All indications regarding ranges of values in the present description are to be understood such that these also comprise random and all partial ranges from it, for example, the indication 1 to 10 is to be understood such that it comprises all partial ranges based on the lower limit 1 and the upper limit 10, i.e. all partial ranges start with a lower limit of 1 or larger and end with an upper limit of 10 or less, for example 1 through 1.7, or 3.2 through 8.1, or 5.5 through 10.

Finally, as a matter of form, it should be noted that for ease of understanding of the structure, elements are partially not depicted to scale and/or are enlarged and/or are reduced in size.

### LIST OF REFERENCE NUMBERS

1 wind turbine 31 main direction of loading
2 tower
3 nacelle
4 rotor
5 rotor blade
6 generator
7 wind turbine gearbox
8 network connection
9 sun gear
10 shaft
11 planetary gear
12 end toothing sun gear
13 end toothing planetary gear
14 planetary gear axle
15 planetary carrier
16 first receiving section
17 second receiving section
18 bearing seat
19 sliding bearing
20 internal gear
21 internal toothing
22 rotor shaft
23 gearbox component
24 bearing seat
25 distance sensor
26 distance
27 marking
28 laser beam
29 rotation center
30 permanent magnet

1. A method for determining the wear of a sliding bearing (19) arranged in a wind turbine gearbox (7), in particular a planetary gearbox, which sliding bearing (19) serves for mounting a gearbox component (23), wherein, by means of at least one distance sensor (25), which is arranged in the wind turbine gearbox (7), a radial displacement of the position or a tilting of the gearbox component (23) pivoted by means of the sliding bearing (19) can be detected.

2. The method according to claim 1, wherein the distance sensor (25) detects the displacement of the gearbox component (23) in periodical intervals, and the measured values are saved in a wear chart.

3. The method according to claim 2, wherein, for the radial displacement or tilting, target values with tolerance ranges are predetermined for a certain time of detection, and the actual values detected by means of the distance sensor (25) are compared with said target values, wherein an action is triggered if an actual value lies outside the tolerance range of an assigned target value.

4. A wind turbine gearbox (7), in particular planetary gearbox, having at least one sliding bearing (19) for mounting a gearbox component (23), wherein a wear sensor in the form of a distance sensor (25) is formed for detecting a radial displacement of the position or tilting of the gearbox component (23) pivoted by means of the sliding bearing (19).

5. The wind turbine gearbox according to claim 4, wherein the distance sensor (25) is arranged on a planetary gear carrier (15) and is formed for the detection of the radial displacement of the position or tilting of a planetary gear axle (14), in particular wherein the distance sensor (25) is arranged on the planetary gear carrier (15) so as to detect the distance (26) in the tangential direction.

6. The wind turbine gearbox according to claim 4, wherein a permanent magnet (30) is arranged in the planetary gearbox such that the distance sensor (25), which is arranged on the planetary gear carrier (15) so as to rotate along with it, can be supplied or charged with electricity by means of induction.

7. The wind turbine gearbox according to claim 4, wherein a laser sensor is formed as a distance sensor (25).

8. The wind turbine gearbox according to claim 4, wherein a marking (27) is arranged on the gearbox component (23), which marking (27) serves as a reference for the distance sensor (25), in particular that wherein the marking (27) is formed as a reflector point which is arranged on the planetary gear axle (14).

9. The wind turbine gearbox according to claim 4, wherein the distance sensor (25) is arranged on the bearing seat (24) of the sliding bearing (19).

10. The wind turbine gearbox according to claim 4, wherein the distance sensor (25) is arranged on the bearing seat (24) such that a radial displacement of the position of the gearbox component (23) pivoted by means of the sliding bearing (19) in the main direction of loading (31) can be detected.
